(19) United States
(12) Patent Application Publication
(10) Pub. No.: US 2021/0199318 A1
(43) Pub. Date: Jul. 1, 2021

(54) AIR TREATMENT UNIT AND METHOD FOR TREATMENT OF AIR

(71) Applicant: Sally R AB, Västerås (SE)

(72) Inventors: Fredrik Edström, Uppsala (SE); Viktor Kjellberg, Västerås (SE); Mohamad Omar Mansour, Västerås (SE)

(73) Assignee: Sally R AB, Västerås (SE)

(21) Appl. No.: 17/056,970

(22) PCT Filed: May 21, 2019
(86) PCT No.: PCT/EP2019/063046

§ 371 Date: Nov. 19, 2020

(30) Foreign Application Priority Data
May 21, 2018 (SE) 1850595-8

(51) Int. Cl. F24F 3/16; B01D 53/86; F24F 8/167; F24F 12/00

(52) U.S. Cl. CPC F24F 3/16; F24F 2203/104; B01D 53/865; B01D 53/8668; F24F 8/167; F24F 12/006; B01D 2255/1021; B01D 2255/1023; B01D 2255/1025; B01D 2255/104; B01D 2255/106; B01D 2255/2094; B01D 2257/708; B01D 2258/06; B01D 2259/4508; F24F 2203/1028; B01D 53/864

(57) ABSTRACT

An air treatment unit (100) arranged for an intake of a first flow (110) of air into a space (120) in communication with the air treatment unit, and arranged for a discharge of a second flow (130) of air from the space. The air treatment unit comprises a heat-exchanging unit (140) arranged for thermal exchange between the second flow of air and the first flow of air, and a catalyst (150) configured to capture at least one impurity of the first flow of air. The catalyst is provided on at least a portion (160) of the heat-exchanging unit arranged to come into contact with the first flow of air during operation of the air treatment unit.

### FIELD OF THE INVENTION

The present invention generally relates to the field of air treatment units. More specifically, the present invention relates to a unit for the treatment or handling of air of a space for improving the quality of the air of that space.

### BACKGROUND OF 1HE INVENTION

According to recent estimations, 1 in t deaths are linked with air pollution. Air pollutions are present both outdoors and indoors, and since people today tend to spend a large amount of their time indoors, controlling the indoor environment is therefore of vital importance.

The field of indoor climate and indoor air quality has numerous aspects which may be divided into aspects relating to comfort and aspects relating to health issues. In the context of this application, comfort climate refers to aspects of climate such as temperature, humidity, odour control, etc. Aspects of health climate on the other hand are closely related to air pollution control. Examples of air pollutions may include e.g. benzene, nitrogen dioxide, sulphur dioxide, carbon monoxide, benzo(a)pyrene, radon, ozone, and volatile organic compounds (VOC) e.g. including hydrocarbons (HC), formaldehyde, alcohols, etc.

In an indoor environment, air pollution origins for example, from humans, furniture, cooking, etc. To control the indoor air pollution levels, the indoor air is therefore commonly let outside and ambient, or outside, air is let inside. Outdoor air may however be for example too hot, cool, humid or polluted. Therefore, to achieve a comfortable and healthy climate, the outside air led inside may have to be cooled or heated depending on the temperature, humidity may have to be added or removed depending on the water content, outdoor air pollutions may have to be removed, etc.

To control the temperature and to add and/or remove water from the outdoor air, heat pumps, or any other cooling machine, can be used. For example, the outdoor air may be cooled to the desired dew point and then heated, in order to obtain a desired temperature and humidity level. However, for this to work the whole year around at a location having varying seasons, the size of the cooling machine must unfortunately be chosen based on the demands on the expected hottest and most humid day.

Furthermore, as mentioned above, if the outside air is too dry, a humidifier must be used to control the humidity and/or if the outside air is polluted, air purifiers must be used to control the air pollution inside. State of the art air purifiers commonly comprise ionizers, HEPA filters, activated carbon beds, ultra violet light, thermal oxidation and catalytic oxidation. However, all these systems add to the energy requirements and the investment bill.

Accordingly, controlling the indoor climate is energy intense, at least in part due to the fact that the expected hottest, coolest and most polluted day of the year sets the size for the constituents in the system. Moreover, these systems often operate at a full capacity even if the building's occupancy is low. Hence both investment- and operating costs for climate control devices tend to be high.

In order to alleviate some of these drawbacks, solutions have been proposed to reduce the energy requirements and/or the size of the system. For example, heat exchangers can be used to transfer energy between the indoor and the outdoor air when ventilating. This may reduce the need for heating and/or cooling. Also, measuring the indoor carbon dioxide and air pollution levels can reduce the ventilation need. If the flow is reduced, the energy needed for temperature, humidity and air pollution control can also be reduced. A system as mentioned above comprising a heat exchanger could be designed as follows: fresh air would usually pass through a coarse filter that removes dust, leaves and other particles with large diameters. After that, it passes through a heat exchanger, where heat is exchanged between air supplied to the building (house) and return air coming back. In this way, the desired supply air temperature is achieved with less energy expense. Consequently, the operation of cooling and/or heating elements, which in some cases are integrated into the system or built separately as chillers and radiators, could be reduced. For example, having an outdoor temperature of −5° C. would require spending some amount of energy through the heaters to reach the supply temperature of 20° C. By exchanging heat with the return air, which might be 24° C., the supply temperature could be elevated from −5 to 20° C. with less energy from those heaters. Similarly, the return air would pass again through another course filter to protect the heat exchanger from dust, after which it is vented outside via the exhaust fan.

In order to increase the efficiency of the filtering capacity of the above-mentioned system, catalyst technologies may be applied. According to the prior art, there are volatile organic compound (VOC) concentrators that serve a similar functionality of a low temperature catalyst. These concentrators utilize a combination of adsorption and catalytic or thermal technologies to concentrate the VOCs for destruction in catalytic or thermal oxidisers. Systems comprising concentrators of this kind may be useful for VOC concentrations that are too high for a cost-effective use of sacrificial systems and too low for a cost-effective use of thermal or catalytic oxidisers. These systems are composed of either activated carbon or zeolite as the adsorbing media to remove the VOCs.

However, systems according to the prior art, such as systems comprising VOC concentrators described above, are associated with numerous problems and/or deficiencies.

First, these systems are usually bulky, and are often too large to be fit into and/or connected to commercial and residential air handling units (AHUs). Second, the prior art systems are associated with a relatively high cost. For example, a system comprising VOC concentrators with an efficiency of 5000 m³/h may cost approximately 15 000-30 000 Euros. For residential and commercial AHUs, this cost is often considered unfeasible. Furthermore, the operation of systems of this kind may include frequent refurbishments of the thermal oxidizer (depending on the VOC concentration to be concentrated) and a heating of the air for the thermal oxidizer to desorb the VOCs. Moreover, since the VOC concentrator comprises zeolite or regenerable carbon, the system may experience a considerable pressure drop. Consequently, the flow rates of fans need to be increased, leading to an increase of the overall system energy consumption. Furthermore, the cleaning of supply and/or exhaust air, which is required for systems of this kind, requires a relatively large piping construction. Apart from an increasing cost associated with this, the construction may increase the system complexity and volume, which is especially problematic in case the space is limited. Hence, alternative solutions are of interest, which alleviate at least some of the above-mentioned problems, and are able to provide a more efficient system in terms of operation, cost, space and/or complexity.

### SUMMARY OF THE INVENTION

It is an object of the present invention to mitigate the above problems and to provide an air treatment unit which is operation-, cost- and space-efficient.

This and other objects are achieved by providing an air treatment unit having the features in the independent claims. Preferred embodiments are defined in the dependent claims.

Hence, according to a first aspect of the present invention, there is provided an air treatment unit. The air treatment unit is arranged for an intake of a first flow of air into a space in communication with the air treatment unit. The unit is further arranged for a discharge of a second flow of air from the space. The air treatment unit comprises a heat-exchanging unit arranged for thermal exchange between the second flow of air and the first flow of air. The air treatment unit further comprises a catalyst configured to capture at least one impurity of at least one of the first flow of air and the second flow of air. The catalyst is provided on at least a portion of the heat-exchanging unit arranged to come into contact with at least one of the first flow of air and the second flow of air during operation of the air treatment unit.

According to a second aspect of the present invention, there is provided an air treatment unit. The air treatment unit is arranged for an intake of a first flow of air into a space in communication with the air treatment unit. The unit is further arranged for a discharge of a second flow of air from the space. The air treatment unit comprises a heat-exchanging unit arranged for thermal exchange between the second flow of air and the first flow of air. The air treatment unit further comprises a catalyst configured to capture at least one impurity of at least one of the first flow of air and the second flow of air. The catalyst is provided on at least a portion of the heat-exchanging unit arranged to come into contact with at least one of the first flow of air and the second flow of air during operation of the air treatment unit. The catalyst comprises from 1-50 weight-%, based on the total weight of the catalyst, of a noble metal selected from the group consisting of platinum, palladium, gold, silver, and rhodium, which has been dispersed on from 50-99 weight-%, based on the total weight of the catalyst, of a metal oxide which possesses more than one stable oxidation state including at least tin oxide, and the first flow of air is ambient outdoor air.

According to a third aspect of the present invention, there is provided a method for treatment of air by an air treatment unit. The air treatment unit is arranged for an intake of a first flow of air into a space in communication with the air treatment unit, and arranged for a discharge of a second flow of air from the space. The air treatment unit comprises a heat-exchanging unit arranged for thermal exchange between the second flow of air and the first flow of air. The method comprising the step of providing a thermal exchange between the second flow of air and the first flow of air by the heat-exchanging unit. The method further comprises the step of providing a catalyst on at least a portion of the heat-exchanging unit, wherein the catalyst is configured to capture at least one impurity of at least one of the first flow of air and the second flow or air. The method further comprises the step of guiding at least one of the first flow of air and the second flow of air to come into contact with the at least one portion of the heat-exchanging unit.

According to a fourth aspect of the present invention, there is provided a method for treatment of air by an air treatment unit. The air treatment unit is arranged for an intake of a first flow of air into a space in communication with the air treatment unit, and arranged for a discharge of a second flow of air from the space. The air treatment unit comprises a heat-exchanging unit arranged for thermal exchange between the second flow of air and the first flow of air. The method comprising the step of providing a thermal exchange between the second flow of air and the first flow of air by the heat-exchanging unit. The method further comprises the step of providing a catalyst on at least a portion of the heat-exchanging unit, wherein the catalyst is configured to capture at least one impurity of at least one of the first flow of air and the second flow or air, and wherein the catalyst comprises from 1-50 weight-%, based on the total weight of the catalyst, of a noble metal selected from the group consisting of platinum, palladium, gold, silver, and rhodium, which has been dispersed on from 50-99 weight-%, based on the total weight of the catalyst, of a metal oxide which possesses more than one stable oxidation state including at least tin oxide. The method further comprises the step of guiding at least one of the first flow of air and the second flow of air to come into contact with the at least one portion of the heat-exchanging unit, wherein the first flow of air is ambient outdoor air.

Thus, the present invention is based on the idea of providing a unit for the treatment and/or handling of air. The air treatment unit comprises a catalyst for capturing and converting impurities of a first flow of air and/or a second flow of air arranged to pass through the air treatment unit via a heat-exchanging unit. The catalyst is provided on one or more portions of the heat-exchanging unit, which portion(s) is (are) configured to come into contact with the first flow of air and/or the second flow of air during operation of the air treatment unit. Consequently, the air treatment unit is able to at least partially purify the first flow or air and/or the second flow of air in a convenient and efficient manner.

The air treatment unit is advantageous in that the catalyst may efficiently oxidize impurities such as VOCs in the first flow of air and/or the second flow of air to CO₂ and H₂O, being non-toxic compounds. After oxidation, the active sites of the catalyst again become available for absorption/oxidation of more VOCs. Compared to filters, the catalyst requires replacement much less often Furthermore, the catalyst of the air treatment unit of the present invention does not retain the VOCs and may therefore constitute a more environmental friendly alternative to filters. It should be noted that the catalyst may convert impurities such as VOCs to harmless gaseous components already found in air. Hence, the catalyst does not contribute to air pollution unlike prior art systems which may be arranged to exhaust polluted air to the environment.

It will be appreciated that the catalyst of the air treatment unit is provided or arranged on one or more portions of the heat-exchanging unit for at least partial purification of the first flow of air and/or the second flow of air, and that the catalyst hereby has relatively small, or almost negligible dimensions, compared to the dimension of the heat-exchanging unit. Hence, the present invention is advantageous in that the air treatment unit is size-efficient, and saves space compared to systems according to the prior art.

Due to the fact that systems or units for the handling or treatment of air are often provided with a heat-exchanger, the present invention is further advantageous in that the air treatment unit is conveniently produced or manufactured, as the catalyst may be provided or arranged on an already existing heat exchanger of the system or unit. Notably, the air treatment unit of the present invention may even be applied to air handling units presently available on the market. More specifically, the present invention may be applied to air handling units already arranged in residential, commercial and/or industrial environments. Hence, the convenience of the air treatment unit may result in an increased efficiency regarding its production or manufacture, or its provision on already existing units or systems, which consequently may lead to an increased cost-efficiency of the air treatment unit.

The air treatment unit of the present invention is further advantageous in that its overall cost is relatively low, predominantly as the cost of the catalyst of the air treatment unit is relatively low. Also, it should be noted that prior art arrangements for the treatment or handling of air, e.g. comprising (rotating) VOC concentrators, are associated with a relatively high cost. Hence, the air treatment unit of the present invention is cost-efficient compared to arrangements of the prior art.

It will be appreciated that the catalyst of the air treatment unit is easily, conveniently and efficiently provided or arranged on (or applied to) the portion(s) of the heat-exchanging unit which is (are) configured to come into contact with the first flow of air and/or the second flow of air during operation of the air handling unit. Hence, the air treatment unit of the present invention is further advantageous in that its operational cost is relatively low, and that the maintenance of the air treatment unit is convenient and efficient regarding time and/or cost. It should be noted that the provision or application of the catalyst of the portion(s) of the heat-exchanging unit may be performed manually or by automated methods, thereby even further contributing to the versatility of the air treatment unit.

The air treatment unit of the present invention is further advantageous in its relatively simple, optimized and efficient configuration. More specifically, as the catalyst of the air treatment unit is provided or arranged on the portion(s) of the heat-exchanging unit for purification of the first flow of air and/or the second flow of air, the air treatment unit may avoid a complex, bulky and/or error-prone arrangement, e.g. comprising a complex piping system.

The air treatment unit of the present invention is further advantageous in that it may eliminate the use of portable air filters in spaces such as rooms, buildings and/or offices. Hence, the air treatment unit may avoid (costly) investments in separate air filtration and/or air treatment units.

It should be noted that the above-mentioned advantages of the air treatment unit of the first and second aspects of the present invention, respectively, also hold for the method for treatment of air according to the third and fourth aspects of the present invention respectively.

According to the invention, there is provided a unit for the handling or treatment of air to and/or from a space, such as a room, building, office, etc. The air treatment unit is arranged for an intake of a first flow of air into a space in communication with the air treatment unit, and arranged for a discharge of a second flow of air from the space. By the term “first flow of air”, it is here meant a supply, inlet and/or intake of a flow of air, preferably outdoor air. Analogously, by the term “second flow of air”, it is here meant a discharge, outlet and/or exhaust of a flow of air from a space, such as a room, building, office, etc. By the term “communication”, it is here meant that the air treatment unit and the space are connected such that air may pass between the air treatment unit and the space. Hence, the air treatment unit is arranged or configured to supply air in the form of a first flow into the space, and to discharge air in the form of a second flow from that same space. The air treatment unit comprises a heat-exchanging unit arranged for thermal exchange between the second flow of air and the first flow of air. By the term “heat-exchanging unit”, it is here meant substantially any element, unit, system, or the like which is configured for heat exchange, such as a heat exchanger. The air treatment unit further comprises a catalyst configured to capture, adsorb and/or absorb at least one impurity of the first flow of air and/or the second flow of air. By the term “catalyst”, it is generally meant a substance that enables a chemical reaction to proceed at a usually faster rate or under different conditions (as at a lower temperature) than otherwise possible. In the context of the present application, the catalyst for capturing and converting impurities may predominantly constitute a low temperature catalyst (LTC). The term “impurity” may, for example, comprise one or more of e.g. benzene, nitrogen dioxide, sulphur dioxide, carbon monoxide, benzo(a)pyrene, radon, and ozone, and may in particular comprise volatile organic compounds (VOC) such as nitrogen (di)oxide(s) (NPₓ), hydrocarbons (HC), formaldehyde, alcohols, etc.

The catalyst is provided on at least a portion of the heat-exchanging unit arranged to come into contact with the first flow of air and/or the second flow of air during operation of the air treatment unit. Hence, the catalyst is provided, arranged and/or applied to on one or more portions of the heat-exchanging unit, wherein this (these) portion(s) is (are) arranged or configured to come into contact and/or be exposed to the first flow of air and/or the second flow of air during operation of the air treatment unit. According to an embodiment of the present invention, the catalyst may comprise a coating provided on the at least a portion of the heat-exchanging unit. By the term “coating”, it is here meant a layer, cover(ing), or the like, which is provided or arranged on, or applied to, the portion.(s) of the heat-exchanging unit. The present embodiment is advantageous in that the catalyst may be provided on the portion(s) of the heat-exchanging unit in an easy and convenient manner. It will be appreciated that the maintenance of the air handling unit furthermore becomes efficient and time-saving, as an operator merely needs to coat the portion(s) of the heat-exchanging unit with the catalyst in case of depletion of the catalyst after operation of the air handling unit. The present embodiment is further advantageous in that providing the catalyst in the form of a coating on the portion(s) of the heat-exchanging unit is particularly size-efficient. In other words, the additional size or dimension of the heat-exchanging unit due to the provision of a coating of the catalyst according to the present invention may be small, or almost negligible.

According to an embodiment of the present invention, the catalyst may comprise an immersion coating arranged for coating the at least a portion of the heat-exchanging unit by immersion of the at least a portion of the heat-exchanging unit into the immersion coating. Hence, the catalyst may be provided in a liquid form, and the coating of the portion(s) of the heat-exchanging unit may be provided by dipping the portion(s) into the liquid catalyst. The present embodiment is advantageous in that the provision or application of the catalyst to the portion(s) of the heat-exchanging unit may be performed in an even more efficient manner with respect to time and/or cost.

According to an embodiment of the present invention, the catalyst may comprise a spray provided on the at least a portion of the heat-exchanging unit. By the term “spray”, it is here meant an aerosol (mist) of liquid particles of the catalyst. The present embodiment is advantageous in that the provision or application of the catalyst to the portion(s) of the heat-exchanging unit in the form of a spray or aerosol may be particularly time-and/or cost efficient.

According to an embodiment of the present invention, the catalyst of the air treatment unit may comprise from 1-50 weight-%, based on the total weight of the catalyst, of a noble metal selected from the group consisting of platinum, palladium, gold, silver, and rhodium, which has been dispersed on from 50-99 weight-%, based on the total weight of the catalyst, of a metal oxide which possesses more than one stable oxidation state including at least tin oxide. The catalyst may be particularly advantageous in case the noble metal is platinum and the metal oxide is tin oxide.

According to an embodiment of the present invention, the heat-exchanging unit may comprise an element which upon rotation is arranged to come into contact with the second flow of air and the first flow of air for thermal exchange between the second flow of air and the first flow of air, and wherein the catalyst is provided on at least a portion of the element. In other words, the element may constitute a rotating element of the heat-exchanging unit of the air treatment unit, and the element may serve as a thermal path between the second and the first flow of air. For example, the heat-exchanging unit of the air treatment unit may be of a so called rotary heat exchanger type, which is a type of energy recovery heat exchanger positioned within the first flow of (supply) air and the second flow of (exhaust) air streams of an air-handling system or in order to recover the heat energy. As the catalyst is provided on at least a portion of the element of the heat-exchanging unit, the present embodiment is advantageous in that this configuration achieves a particularly efficient combination of air purification of the first flow of air and/or the second flow of air, on the one hand, and heat-exchange between the second and the first flow of air, on the other hand, contributing to the overall efficiency of the air treatment unit.

According to an embodiment of the present invention, the element may be shaped as a disc, and wherein the catalyst is provided on at least a portion on at least one of the sides of the disc. For example, the heat-exchanging unit may be a rotary heat exchanger type as described above, and the disc-shaped element is configured to rotate upon operation of the heat-exchanging unit. The disc-shaped element is hereby arranged to come into contact with the second flow of air and the first flow of air upon rotation of the element, for thermal exchange between the second flow of air and the first flow of air. The catalyst is provided on at least one of the sides of the element for efficiently capturing at least one impurity of the first flow of air and/or the second flow of air.

According to an embodiment of the present invention, the element may be shaped as a disc of concentrically arranged layers, and wherein the catalyst is provided on at least a portion of an edge of at least one of the layers of the element. In other words, the (rotating) disc-shaped element of the heat-exchanging unit of the air treatment unit may comprise circular, concentrically arranged layers, wherein the catalyst is provided on one or more circumferential edges of the layers on one or more portions thereof. The present embodiment is advantageous in that the element of the heat-exchanging unit, which element is exposed to the first and second flow of air during operation of the air treatment unit, may efficiently purify the first flow of air and/or the second flow of air via the catalyst provided on the element.

According to an embodiment of the present invention, the heat-exchanging unit may comprise at least one tube for guiding at least one of the first flow of air and the second flow of air, wherein the catalyst is provided on at least a portion of the inside of the at least one tube. For example, the heat-exchanging unit of the air treatment unit according to this embodiment may be of a so called shell and tube heat exchanger type, which may comprise a shell with a bundle of tubes inside it. For example, the heat-exchanging unit may comprise at least one first tube through which the first flow of air is arranged to flow, and may further comprise one or more second tubes in thermal contact with the first tube(s), wherein the second flow of air is arranged to flow through the second tube(s) to transfer heat between the second flow of air and the first flow of air via the first and second tube(s). It will be appreciated that the first and/or second tube(s) for the passage and/or guidance of the first flow of air and/or the second flow of air of the heat-exchanging unit of the air treatment unit of the present embodiment may be exposed to the first flow of air and/or the second flow of air to a relatively high extent. Hence, the present embodiment is advantageous in that and the provision of the catalyst of portion(s) of the inside of the first and/or second tube(s) may hereby lead to a particularly efficient purification of the first flow of air and/or the second flow of air.

According to an embodiment of the present invention, the heat-exchanging unit may comprise at least one first passage for guiding the first flow of air and at least one second passage for guiding the second flow of air. The air treatment unit may further comprise at least one plate arranged to separate the at least one first passage and the at least one second passage and arranged for thermal exchange between the second flow of air and the first flow of air, wherein the catalyst is provided on at least a portion of the at least one plate. For example, the heat-exchanging unit of the air treatment unit according to this embodiment may be of a so called plate heat exchanger type. This kind of heat exchanger may use (metal) plates to transfer heat between two fluids, in this case the first flow of air and the second flow of air. The heat-exchanging unit of the air treatment unit according to this embodiment has a major advantage over a conventional heat exchanger in that the first flow of air and the second flow of air are exposed to a much larger surface area, as the first and second flows of air are spread out over the plates. Consequently, the catalyst provided on the portion(s) of the plate(s) may, to an even further extent, purify the flow of first air and/or the second flow of air during operation of the air treatment unit. Furthermore, the transfer of heat is facilitated by the heat-exchanging unit of the present embodiment, and greatly increases the speed of the temperature change of the first flow of air.

According to an embodiment of the present invention, the heat-exchanging unit may comprise at least one material selected from the group consisting of aluminum, copper, and zinc. Hence, the portion(s) of the heat-exchanging unit of the air treatment unit upon which the catalyst is provided or arranged, may comprise aluminum, copper, and/or zinc. For example, the heat-exchanging unit may consist of aluminum, copper, or zinc, or alternatively, consist of an alloy comprising one or more of these materials, e.g. brass. The present embodiment is advantageous in that these materials have specifically advantageous adhesive properties which are beneficial for the life span and/or functionality of the catalyst arranged on the portion(s) of the heat-exchanging unit.

According to an embodiment of the present invention, there is provided an air treatment system comprising an air treatment unit according to any one of the previous embodiments. The air treatment system further comprises at least one filter arranged for filtering at least one of the first flow of air and the second flow of air, wherein the catalyst is provided on at least a portion of the at least one filter. For example, the air treatment system may comprise at least one first filter arranged to filter the first flow of air before the first flow of air is further guided to the air treatment unit. Analogously, the air treatment system may comprise at least one second filter arranged to filter the second flow of air before the second flow of air from the space is further guided to the air treatment unit. The present embodiment is advantageous in that the filters may remove relatively large particles, such as dust, leaves and/or other particles of relatively large diameters, and at the same time purify the first and/or second flows of air by the catalyst provided on the filter(s). The air treatment system is particularly advantageous in that one or more of the advantages of the provision or application of the catalyst to the portion(s) of the heat-exchanging unit of the air treatment unit also hold for the provision or application of the catalyst to the portion(s) of the filter(s) of the air treatment system. For example, the catalyst has relatively small, or almost negligible dimensions, compared to the dimension of the filter(s). Furthermore, the catalyst may be applied to one or more filters already arranged in residential, commercial and/or industrial environments. Moreover, the catalyst of the air treatment system is easily, conveniently and efficiently provided or arranged on (or applied to) the portion(s) of the filter(s) which is (are) configured to come into contact with the first and/or second flows of air during operation of the air treatment system. Consequently, the air treatment system is able to at least partially purify the first flow of air and/or the second flow of air in a convenient, (cost) efficient and space-saving manner.

According to an embodiment of the present invention, there is provided an air treatment arrangement comprising an air treatment unit according to any one of the previous embodiments. The air treatment arrangement further comprises at least one fan arranged for generating at least one of the first flow of air and the second flow of air, wherein the catalyst is provided on at least a portion of the at least one fan. For example, the air treatment arrangement may comprise at least one first (supply) fan arranged to generate the first flow of air and at least one second (exhaust) fan arranged to generate the second flow of air. The air treatment arrangement is particularly advantageous in that one or more of the advantages of the provision or application of the catalyst to the portion(s) of the heat-exchanging unit of the air treatment unit also hold for the provision or application of the catalyst to the portion(s) of the fan(s) of the air treatment arrangement. For example, the catalyst has relatively small, or almost negligible dimensions, compared to the dimension of the fan(s). Furthermore, the catalyst may be applied to one or more fans already arranged in residential, commercial and/or industrial environments. Moreover, the catalyst of the air treatment arrangement is easily, conveniently and efficiently provided or arranged on (or applied to) the portion(s) of the first and/or second fan(s) which is (are) configured to come into contact with the first and/or second flows of air during operation of the air treatment arrangement. Consequently, the air treatment arrangement is able to at least partially purify the first flow of air and/or the second flow of air in a convenient, (cost) efficient and space-saving manner.

According to an embodiment of the present invention, there is provided an air handling system comprising an air treatment system and an air treatment arrangement according to the previously described embodiments. Hence, the air handling system may be arranged for an intake of a first flow of air into a space in communication with the air treatment unit, and arranged for a discharge of a second flow of air from the space. The air handling unit of the air handling system may comprise a heat-exchanging unit arranged for thermal exchange between the second flow of air and the first flow of air. The air handling unit of the air handling system may further comprise a catalyst configured to capture at least one impurity of at least one of the first flow of air and the second flow of air. The catalyst is provided on at least a portion of the heat-exchanging unit arranged to come into contact with at least one of the first flow of air and/or the second flow of air during operation of the air treatment unit. The air handling system may further comprise at least one filter arranged for filtering at least one of the first flow of air and the second flow of air, wherein the catalyst is provided on at least a portion of the at least one filter. The air handling system may further comprise at least one fan arranged for generating at least one of the first flow of air and the second flow of air, wherein the catalyst is provided on at least a portion of the at least one fan.

According to an embodiment of the method of the third aspect of the present invention, the step of providing the catalyst comprises coating the at least one portion of the heat-exchanging unit with the catalyst,

According to an embodiment of the third aspect of the present invention, the step of providing the catalyst comprises spraying the at least one portion of the heat-exchanging unit with the catalyst.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiment(s) of the invention.

FIG. 1 is a schematic view of a system for the treatment of air according to the prior art,

FIG. 2 is a schematic view in cross-section of an air treatment unit according to an exemplifying embodiment of the present invention,

FIGS. 3-5 are schematic views of portions of a heat-exchanging unit of an air treatment unit according to an exemplifying embodiment of the present invention.

FIG. 6 is a schematic view of an air handling system according to exemplifying embodiment of the present invention, and

FIGS. 7-8 are schematic views of catalysts according to exemplifying embodiments of the present invention.

### DETAILED DESCRIPTION

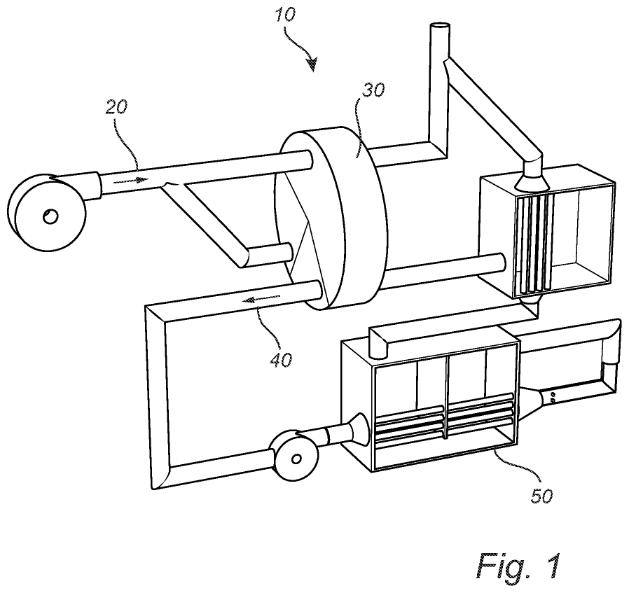

FIG. 1 shows a system 10 for the treatment of air according to the prior art. The system 10 utilizes a combination of adsorption and catalytic or thermal technologies to concentrate volatile organic compounds (VOCs) for destruction in a catalytic or thermal oxidizer. A main air flow 20 passes through a concentrator wheel 30 of the system 10 for a concentration of the VOCs. At the same time, a second air flow 40 is passed through the concentrator wheel 30 in the opposite direction. The second air flow 40 desorbs the VOCs from the concentrator wheel 30 and the VOCs are destroyed in a catalytic or thermal oxidizer 50. The system 10 comprising a concentrator wheel 30 of this kind may be useful for VOC concentrations that are too high for a cost-effective use of sacrificial systems and too low for a cost-effective use of thermal or catalytic oxidisers. However, systems of this kind according to the prior art are associated with numerous problems and/or deficiencies. First, these systems are usually bulky, and are often too large to be fit into and/or connected to commercial and residential air handling units (AHUs). Second, the prior art systems are associated with a relatively high costs. Furthermore, during an operation of systems of this kind, the VOC concentrator wheel 30 may require frequent refurbishments of the thermal oxidizer (depending on the VOC concentration to be concentrated) and a heating of the air for the thermal oxidizer to desorb the VOCs. Moreover, since the VOC concentrator wheel 30 may comprise zeolite or regenerable carbon, the system may experience a considerable pressure drop. Consequently, the flow rates of fans in the system 10 need to be increased, leading to an increase of the overall energy consumption of the system 10. Furthermore, the cleaning of exhaust air, which is required for systems of this kind, requires a relatively large piping construction. Apart from an increasing cost associated with this, the construction may increase the system complexity and volume, which is especially problematic in case the space is limited.

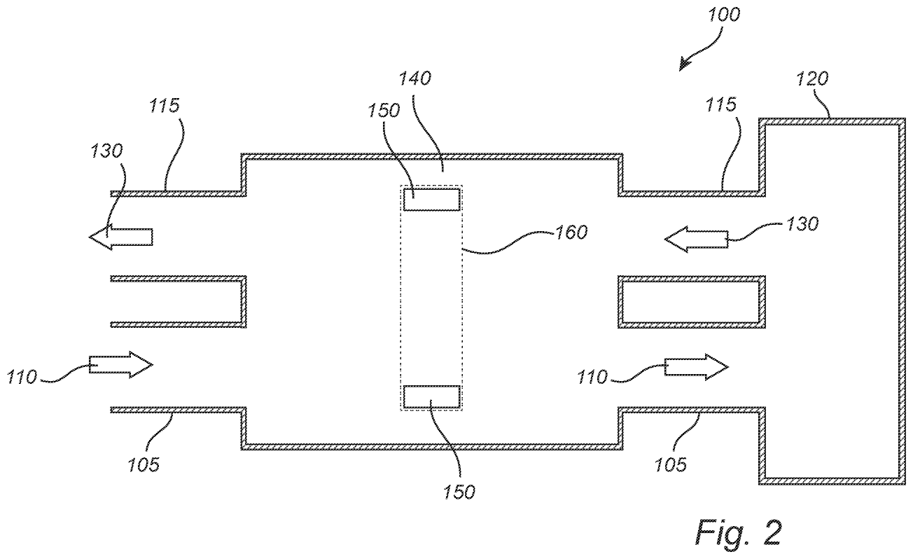

FIG. 2 is a schematic view in cross-section of an air treatment unit 100 according to an exemplifying embodiment of the present invention. The air treatment unit 100 comprises an inlet 105, e.g. in the form of a first tubing, for the intake and guiding of a first flow 110 of air. It will be appreciated that the air of the first flow 110 of air may be ambient, outdoor air. The first flow 110 of air may be further distributed by the air treatment unit 100 into a space 120 which is in (fluid) communication with the air treatment unit 100. The space 120 may, for example, be a room, building, office, or the like. The air treatment unit 100 is further in (fluid) communication with the space 120 and arranged for a discharge and guiding of a second flow 130 of air from the space 120 via an outlet 115, e.g. in the form of a second tubing, of the air treatment unit 100. The air treatment unit 100 further comprises a heat-exchanging unit 140 which is arranged for thermal exchange between the second flow 130 of air and the first flow 110 of air. It will be appreciated that the heat-exchanging unit 140 may be of substantially of any type suitable for thermal exchange between the second flow 130 of air and the first flow 110 of air. For example, the heat-exchanging unit 140 may be of a so called rotary heat exchanger type, a shell and tube heat exchanger type or a plate heat exchanger type.

The air treatment unit 100 further comprises a catalyst 150 which is configured to capture, adsorb and/or absorb, and to convert, at least one impurity of the first flow 110 of air and/or the second flow 130 of air. More specifically, the catalyst 150 may capture, adsorb and/or adsorb the impurity/impurities of the first flow 110 of air and/or the second flow 130 of air, enable a reaction between the impurity/impurities and an oxidizing agent, and desorb the oxidation products, thereby freeing sites for subsequent absorptions and reactions. Hence, the catalyst 150 may capture one or more impurities such as benzene, nitrogen oxide (NOₓ), sulphur dioxide, carbon monoxide, benzo(a)pyrene, radon, ozone, etc., and convert (oxidize) one or more of these impurities into non-toxic components such as CO₂, H₂O, etc. The catalyst 150 may be particularly suitable, configured and/or adapted for capturing or absorbing volatile organic compounds (VOC) e.g. including hydrocarbons (HC), formaldehyde, alcohols, etc., and convert (oxidize) one or more of these impurities.

The catalyst 150 of the air treatment unit 100 may comprise or constitute (platinum coated) tin dioxide (SaO₂). For example, the weight percent of the platinum in platinum coated tin dioxide may be in the range of 3-20%. Particles of platinum-coated SnO₂ may be fabricated in a size-range that is comparable to the pigments of paint products that can be brushed or sprayed onto portion(s) of the heat-exchanging unit 140. For example, the particles may have diameters in the order of 10 μm or less.

Alternatively, the catalyst 150 of the air treatment unit 100 may comprise at least two precious metals with at least two different metal-oxides (for example, tin oxide plus one or more promoters) in a layered matrix. Precious metals can together comprise about 0.1-15 weight-% of the catalyst 150. The at least one promoter metal oxide may be chosen from metal oxide species from the transition series of the periodic table which are known to adsorb NOₓ species, namely, Fe₂O₃, NiO, Co₂O₃ and WO₃. The composition of the promoter oxide(s) can vary from about 1-15 weight-% of the total catalyst 150 material. Specifically, about 10 weight-% of the catalyst may be Fe₂O, NiO, Co—O, combined with about 1.25 weight-% of the catalyst 150 being platinum and ruthenium, with the balance being tin oxide. For example, the catalyst 150 may comprise 70-99 weight-% of a metal oxide possessing more than one oxidation state (e.g. tin oxide), 0.1-15 weight-% of at least two precious metals of which one is Ru and the other is chosen from the group consisting of platinum (Pt), palladium (Pd), gold (Au), rhodium (Rh) and silver (Ag). The catalyst 150 may further comprise 1-15 weight-% of at least one promoter selected from the group consisting of Fe₂O₃, NiO, Co₂O₃ and WO₃. It will be appreciated that the catalyst 150 as exemplified is associated with numerous advantages. For example, the relatively low light-off temperatures for CO and HC may enable an even more efficient catalytic conversion to CO₂ at a lower cost. The precious metal coatings may be applied to the top surface of the catalyst 150 and are enabled to be more efficiently used. Consequently, less precious metals may be required resulting in lower costs. Moreover, the mixed precious metals may result in a more efficient oxidation/reduction catalyst 150 and may be applied in one step.

As yet another alternative, the catalyst 150 of the air treatment unit 100 may comprise 1-50 weight-% of a noble metal selected from the group consisiting of platinum (Pt), palladium (Pd), gold (Au), rhodium (Rh) and silver (Ag). The noble metal may have been dispersed on from about 50-99 weight-% of a metal oxide which possesses more than one stable oxidation state including at least tin oxide. The preparation of such a platinum-tin oxide-based catalyst 150 may be accomplished by successive layering of the desired components, as follows: (1) a clean, dry substrate may be deaerated in a solution containing tin (H) 2-ethylhexanoate (SnEH, hereafter). The substrate is removed from the solution, and excess solution is removed from the substrate. Residual solution components are evaporated leaving an SnEH layer on the substrate which is thermally decomposed in air to tin oxide at 300° C. Several layers may be applied in the same manner to achieve the desired loading of tin oxide. (2) If desired, a promoter is added to the catalyst matrix in a similar fashion. For example, an iron oxide promoter may be added to an existing tin oxide-coated substrate by dearating in an iron nitrate solution, removing excess solution, evaporating the solvent, and finally thermally decomposing the nitrate to oxide, (3) Platinum may be added to the coated, substrate as above using an aqueous solution of tetraamine platinum (II) dihydroxide or other platinum salt, with chloride-fee salts being preferred, and then thermally decomposing the salt. Instead of the thermal decomposition, a reductive decomposition can be used. For example, the catalyst coated substrate is heated in an atmosphere containing a reducing gas such as carbon monoxide or hydrogen to induce reduction of the platinum salt to platinum.

The active temperature of the catalyst 150 of the air handling unit 100 may be −10° C.-500° C. For example, for conversion of formaldehyde (CH₂O), the temperature of the catalyst 150 may be 0° C.-25° C., or even somewhat lower. For hydrocarbons (HC), desorption may take place from an initial temperature of the catalyst 150 of about 35° C., and oxidation may be performed at an active temperature of the catalyst 150 at 80° C.-120° C. The light-off temperature may be about 150° C. for hexane (C₆H₁₄) and about 220° C. for methane (CHS). A complete oxidation may occur at an active temperature of the catalyst 150 well below the autoignition temperature of each hydrocarbon, e.g. 309° C. for pentane (C₅H₁₂) and 537° C. for methane. As yet another example, the temperature of the catalyst 150 for oxidation of ethanol (C₂H₅OH) may be about 30° C., and complete oxidization may be achieved at 125° C. Analogously, for propanol (C₃H₇OH), the respective temperatures of the catalyst may be 50° C. and 120° C. For the oxidation of carbon monoxide (CO) and the reduction of nitrogen oxides (NOₓ), the active temperature of the catalyst 150 may be 200° C. -500° C. The catalyst 150 is provided on at least a portion 160 of the heat-exchanging unit 140, which portion(s) 160 is (are) arranged to come into contact with the first flow 110 of air and/or the second flow 130 of air during operation of the air treatment unit 100. It will be appreciated that the arrangement of the catalyst portion 150 on the portion(s) 160 of the heat-exchanging unit 140, as well as the portion(s) 160 itself, are schematically indicated for an increased understanding of the concept of the present invention. In other words, the portion 160 of the heat-exchanging unit 140 of the air treatment unit 100 is schematically shown for illustrative purposes only, and it should be noted that the portion(s) 160 may take on substantially any form on and/or of the heat-exchanging unit 140 of the air treatment unit 100.

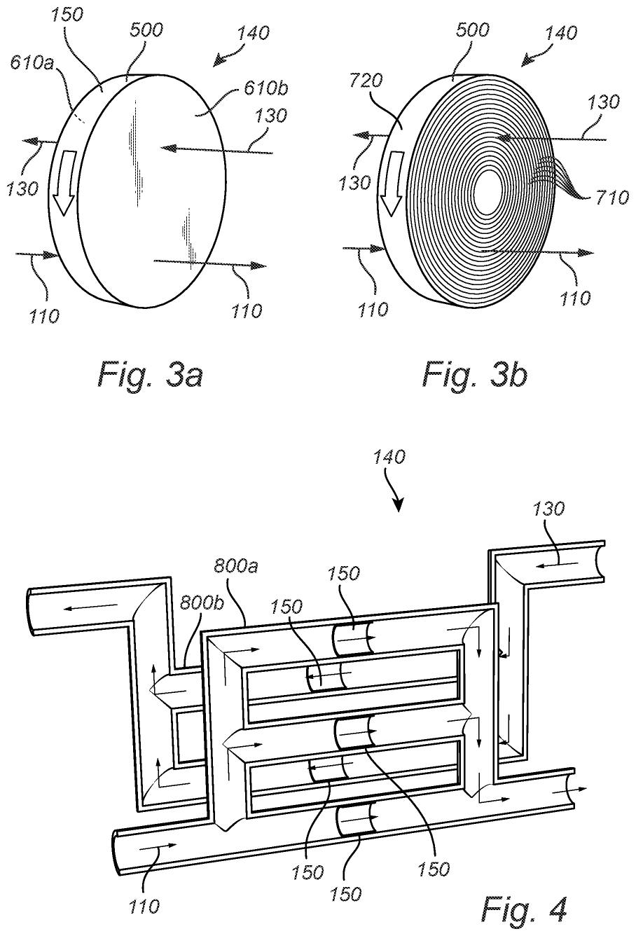

FIG. 3a is a schematic view of a portion of a heat-exchanging unit 140 of an air treatment unit 100 according to an exemplifying embodiment of the present invention. In this example, the heat-exchanging unit 140 is of a so called rotary heat exchanger type, and comprises a disc-shaped element 500 which is configured to rotate upon operation of the heat-exchanging unit 140. More specifically, the element 500 is arranged to come into contact with the second flow 130 of air and the first flow 110 of air upon rotation of the element 500, for thermal exchange between the second flow 130 of air and the first flow 110 of air. The catalyst 150 is provided on at least one of the sides 610a, 610h of the element 500 for capturing at least one impurity of the first flow 110 of air and/or the second flow 130 of air. FIG. 3b is a schematic view of a portion of a heat-exchanging unit 140 of an air treatment unit 100 according to an exemplifying embodiment of the present invention. Analogously with the example of FIG. 3a, the heat-exchanging unit 140 is of a so called rotary heat exchanger type. The heat-exchanging unit 140 comprises a disc-shaped element 500 which is configured to rotate upon operation of the heat-exchanging unit 140 and is arranged to come into contact with the second flow 130 of air and the first flow 110 of air upon rotation of the element 500. The element 500 is shaped as a disc of concentrically arranged layers 710. and the catalyst 150 is provided on at least a portion of an edge 720 of at least one of the layers of the element 500 for capturing at least one impurity of the first flow 110 of air and/or the second flow 130 of air.

It should be noted that a combination of the examples of FIG. 3a and FIG. 3b is also feasible. More specifically, the catalyst 150 may be provided on at least one of the sides 610a, 610b of the element 500, as shown in FIG. 3a, as well as on the on at least a portion of an edge 720 of at least one of the layers of the element 500, as shown in FIG. 3b.

FIG. 4 is a schematic view of a portion of a heat-exchanging unit 140 of an air treatment unit according to an exemplifying embodiment of the present invention The heat-exchanging unit comprises at least one first tube or tubing 800a for guiding the first flow 110 of air into a space (not shown), and at least one second tube or tubing 800a for discharging and guiding the second flow 130 of air away from the space. The first tube(s) or tubing(s) 800a and the second tube(s) or tubing(s) 800a are arranged adjacently and are in thermal connection. The second flow 130 of air is arranged to flow through the second tube(s) or tubing(s) 800b to transfer heat between the second flow 130 of air and the first flow 110 of air arranged to flow through the first tube(s) or tubing(s) 800a. The catalyst 150 of the air treatment unit is provided on at least a portion of the inside of the first tube(s) or tubing(s) 800a and/or the second tube(s) or tubing(s) 800b for capturing at least one impurity of the first flow 110 of air and the second flow 130 of air. It will be appreciated that the catalyst 150 may be arranged on different portion(s) than those indicated in FIG. 4, which is provided for an illustrative purpose only. Furthermore, it should be noted that the first tube(s) or tubing(s) 800a and/or the second tube(s) or tubing(s) 800b of the heat-exchanging unit 140 may be arranged differently than disclosed in FIG. 4.

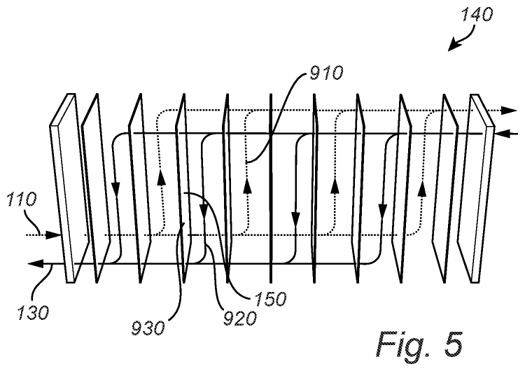

FIG. 5 is another schematic view of a portion of a heat-exchanging unit 140 of an air treatment unit according to an exemplifying embodiment of the present invention. The heal-exchanging unit 140 comprises at least one first passage 910 for guiding the first flow 110 of air. Analogously, the heat-exchanging unit 140 comprises at least one second passage 920 for guiding the second flow 130 of air. The heat-exchanging unit 140 further comprises at least one plate 930 arranged to separate the first passage(s) 910 and the second passage(s) 920. The plate(s) 930 is (are) arranged for a thermal exchange between the second flow 130 of air and the first flow 110 of air. The catalyst 150 of the air treatment unit is provided on at least a portion of the plate(s) 930 for capturing impurities of the first flow 110 of air and/or the second flow 130 of air. It will be appreciated that the catalyst 150 may be arranged on different portion(s) of the plate(s) 930 and/or on different plate(s) 930 than that (those) indicated in FIG. 5, which is provided for an illustrative purpose only.

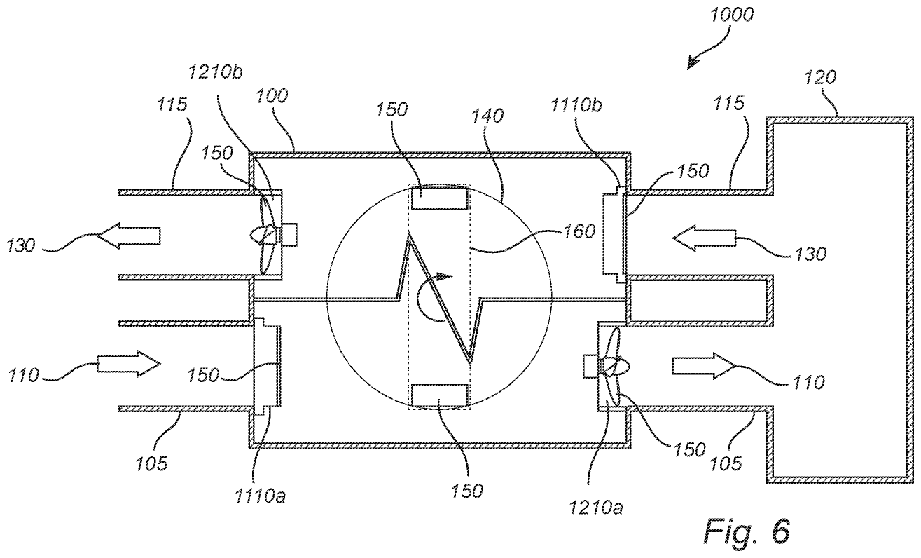

FIG. 6 is a schematic view of an air handling system 1000 according to an exemplifying embodiment of the present invention. The air handling system 1000 comprises an air treatment unit 100 as exemplified in FIG. 2. The air handling system 1000 further comprises an inlet 105 arranged for an intake of a first flow 110 of air into a space 120 of the air handling system 1000. The inlet 105, which is exemplified as a tubing, is in communication with the space 120 via the air treatment unit 100. The air handling system 1000 further comprises an outlet 115, exemplified as a tubing, which is arranged for a discharge of a second flow 130 of air from the space 120. The space 120 is in communication with the outlet 115 via the air treatment unit 100. The air treatment unit 100 comprises a heat-exchanging unit 140 which is arranged for thermal exchange between the second flow 130 of air and the first flow 110 of air as described according to one or more of the previous embodiments. The air treatment unit 100 further comprises a catalyst 150 which is configured to capture at least one impurity of the first flow 110 of air and/or the second flow 130 of air. The catalyst 150 is provided on at least a portion 160 of the heat-exchanging unit 140, which portion(s) is (are) arranged to come into contact with the first flow 110 of air and/or the second flow 130 of air during operation of the air treatment unit 100 of the air handling system 1000. Similar to FIG. 2, it will be appreciated that the arrangement of the catalyst portion 150 on the portion(s) 160 of the heat-exchanging unit 140, as well as the porn on(s) 160 itself, are schematically indicated for an increased understanding of the concept of the present invention.

The air handling system 1000 in FIG. 6 further comprises a first filter 1110a arranged in the inlet 105 and upstream of the air treatment unit 100 in the direction of the first flow 110 of air. The first filter 1110a is arranged for filtering the first flow 110 of air before entering the space 120 of the air handling system 1000. The air handling system 1000 further comprises a second filter 1110b arranged in the outlet 115 and upstream of the air treatment unit 100 in the direction of the second flow 130 of air, for filtering the second flow 130 of air. The first filter 1110a and/or the second filter 1110b may, for example, constitute one or more coarse filters for filtering debris of the air, such as leaves, relatively large particles, dust, pollen, etc. The catalyst 150 of the air treatment unit 100 of the air handling system 1000 may be provided on at least a portion of the first filter 1110a and/or the second filter 1110b for capturing impurities of the first flow 110 of air and/or the second flow 130 of air.

The air handling system 1000 further comprises a first fan 1210a arranged for generating the first flow 110 of air towards the space 120 of the air handling system 1000, The first fan 1210a is arranged in the inlet 105 and downstream of the air treatment unit 100 in the direction of the first flow 110 of air. Analogously, the air handling system 1000 further comprises a second fan 1210b arranged for generating the second flow 130 of air from the space 120 of the air handling system 1000. The second fan 1210b is arranged in the outlet 105 and downstream of the air treatment unit 100 in the direction of the second flow 110 of air, The catalyst 150 of the air treatment unit 100 of the air handling system 1000 may be provided on at least a portion of the first fan 1210a and/or the second fan 1210b for capturing impurities of the first flow 110 of air and/or the second flow 130 of air arranged to pass the first fan 1210a and/or the second fan 1210b.

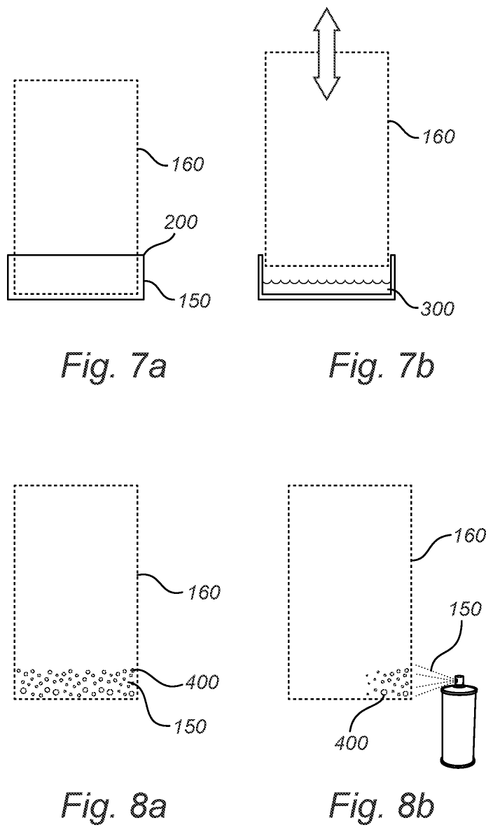

FIG. 7a is a schematic view of a catalyst coating 200 according to an exemplifying embodiment of the present invention. A portion 160 of the heat-exchanging unit of the air treatment unit is schematically shown for illustrative purposes only, and it should be noted that the portion 160 may take on substantially any form and/or be part of one or more elements and/or units of the air treatment unit. For example, the portion 160 may be a portion 160 of a heat-exchanging unit, a filter, a fan, a passage, a duct, a tubing, or the like, according to one or more of the above-mentioned examples. The catalyst 150 comprises a coating 200 provided on the portion 160. Wherein the coating 200 is arranged for capturing impurities of an air flow. FIG. 7b schematically shows the provision of the catalyst on the portion 160 according to a method of the present invention. Here, the method comprises an immersion coating 300 of the portion 160, i.e. immersion or dipping of the portion 160 into a solution of the catalyst.

FIG. 8a is a schematic view of a provision of a catalyst 150 on a portion 160 of a heat-exchanging unit according to an exemplifying embodiment of the present invention. Analogously with FIG. 7a, the portion 160 of the heat-exchanging unit of the air treatment unit is schematically shown for illustrative purposes only, and it should be noted that the portion may take on substantially any form. Here, the catalyst 150 is provided in the form of a spray 400 (i.e. liquid particles) on the portion 160, wherein the catalyst 150 is arranged for capturing impurities of an air flow. The catalyst 150 may be dispersed in a porous sol-gel binder, and be applied in the form of a spray 400 while the sol-gel binder is in its solution state. FIG. 8b schematically shows the associated provision of the catalyst 150 on the portion 160 of a heat-exchanging unit according to a method of the present invention. Here, the catalyst 150 is sprayed on the portion 160 of the heat exchanging unit, such that the spray 400 of liquid particles are provided on the portion 160.

The person skilled in the art realizes that the present invention by no means is limited to the preferred embodiments described above. On the contrary, many modifications and variations are possible within the scope of the appended claims. For example, it will be appreciated that the figures are merely schematic views of printer units according to embodiments of the present invention. Hence, any elements/components of the air treatment unit 100 and/or the air treatment system 1000 such as the heat exchanging unit 140, the inlet 105, the outlet 115, the first filter 1110a, the second filter 1110b, the first fan 1210a, the second fan 1210b, etc., may have different dimensions, shapes and/or sizes than those depicted and/or described.

1.-16. (canceled)

17. An air treatment unit arranged for an intake of a first flow of air into a space in communication with the air treatment unit, and arranged for a discharge of a second flow of air from the space, the air treatment unit comprising:
a heat-exchanging unit arranged for thermal exchange between the second flow of air and the first flow of air, and
a catalyst configured to capture at least one impurity of at least one of the first flow of air and the second flow of air,
wherein the catalyst is provided on at least a portion of the heat-exchanging unit arranged to come into contact with at least one of the first flow and the second flow of air during operation of the air treatment unit,
wherein the catalyst comprises from 1-50 weight-%, based on the total weight of the catalyst, of a noble metal selected from the group consisting of platinum, palladium, gold, silver, and rhodium, which has been dispersed on from 50-99 weight-%, based on the total weight of the catalyst, of a metal oxide which possesses more than one stable oxidation state including at least tin oxide, and wherein the first flow of air is ambient outdoor air.

18. The air treatment unit of claim 17, wherein the catalyst comprises a coating provided on the at least a portion of the heat-exchanging unit.

19. The air treatment unit of claim 17, wherein the catalyst comprises an immersion coating arranged for coating the at least a portion of the heat-exchanging unit by immersion of the at least a portion of the heat-exchanging unit into the immersion coating.

20. The air treatment unit of claim 17, wherein the catalyst comprises a spray provided on the at least a portion of the heat-exchanging unit.

21. The air treatment unit of claim 17, wherein the heat-exchanging unit comprises an element which upon rotation is arranged to come into contact with the second flow of air and the first flow of air for thermal exchange between the second flow of air and the first flow of air, and wherein the catalyst is provided on at least a portion of the element.

22. The air treatment unit of claim 21, wherein the element is shaped as a disc, and wherein the catalyst is provided on at least a portion of at least one of the sides of the disc.

23. The air treatment unit of claim 21, wherein the element is shaped as a disc of concentrically arranged layers, and wherein the catalyst is provided on at least a portion of an edge of at least one of the layers of the element.

24. The air treatment unit of claim 17, wherein the heat-exchanging unit comprises at least one tube for guiding at least one of the first flow of air and the second flow of air, wherein the catalyst is provided on at least a portion of the inside of the at least one tube.

25. The air treatment unit of claim 17, wherein the heat-exchanging unit comprises at least one first passage for guiding the first flow, at least one second passage for guiding the second flow, and at least one plate arranged to separate the at least one first passage and the at least one second passage and arranged for thermal exchange between the second flow of air and the first flow of air, wherein the catalyst is provided on at least a portion of the at least one plate.

26. The air treatment unit of claim 17, wherein the heat-exchanging unit comprises at least one material selected from the group consisting of aluminum, copper, and zinc.

27. An air handling system comprising:
an air treatment unit arranged for an intake of a first flow of air into a space in communication with the air treatment unit, and arranged for a discharge of a second flow of air from the space, the air treatment unit comprising:
a heat-exchanging unit arranged for thermal exchange between the second flow of air and the first flow of air, and
a catalyst configured to capture at least one impurity of at least one of the first flow of air and the second flow of air,
wherein the catalyst is provided on at least a portion of the heat-exchanging unit arranged to come into contact with at least one of the first flow and the second flow of air during operation of the air treatment unit,
wherein the catalyst comprises from 1-50 weight-%, based on the total weight of the catalyst, of a noble metal selected from the group consisting of platinum, palladium, gold, silver, and rhodium, which has been dispersed on from 50-99 weight-%, based on the total weight of the catalyst, of a metal oxide which possesses more than one stable oxidation state including at least tin oxide, and
wherein the first flow of air is ambient outdoor air, p1 an inlet arranged for an intake of a first flow of air into a space of the air handling system, wherein the inlet is in communication with the space via the air treatment unit, and
an outlet arranged for a discharge of a second flow of air from the space, wherein the space is in communication with the outlet via the air treatment unit.

28. The air handling system of claim 27, wherein the air handling system further comprises at least one filter arranged for filtering at least one of the first flow of air and the second flow of air, wherein the catalyst is provided on at least a portion of the at least one filter.

29. The air handling system of claim 27, wherein the air handling arrangement further comprises at least one fan arranged for generating at least one of the first flow of air and the second flow of air, wherein the catalyst is provided on at least a portion of the at least one fan.

30. A method for treatment of air by an air treatment unit arranged for an intake of a first flow of air into a space in communication with the air treatment unit, and arranged for a discharge of a second flow of air from the space, wherein the air treatment unit comprises a heat-exchanging unit arranged for thermal exchange between the second flow of air and the first flow of air, the method comprising the steps of:
providing a thermal exchange between the second flow of air and the first flow of air by the heat-exchanging unit,
providing a catalyst on at least a portion of the heat-exchanging unit, wherein the catalyst is configured to capture at least one impurity of at least one of the first flow of air and the second flow of air, and wherein the catalyst comprises from 1-50 weight-%, based on the total weight of the catalyst, of a noble metal selected from the group consisting of platinum, palladium, gold, silver, and rhodium, which has been dispersed on from 50-99 weight-%, based on the total weight of the catalyst, of a metal oxide which possesses more than one stable oxidation state including at least tin oxide, and guiding at least one of the first flow of air and the second flow of air to come into contact with the at least one portion of the heat-exchanging unit, wherein the first flow of air is ambient outdoor air.

31. The method of claim 30, wherein the step of providing the catalyst comprises coating the at least one portion of the heat-exchanging unit with the catalyst.

32. The method of claim 30, wherein the step of providing the catalyst comprises spraying the at least one portion of the heat-exchanging unit with the catalyst.
